(19) United States
(12) Patent Application Publication
(10) Pub. No.: US 2018/0203893 A1
(43) Pub. Date: Jul. 19, 2018

(54) DYNAMICALLY RECONCILING OBJECTS FROM MULTIPLE SOURCES

(71) Applicant: International Business Machines Corporation, Armonk, NY (US)

(72) Inventors: Lukasz Cmielowski, Krakow (PL); Marek Franczyk, Bojszowy (PL); Tymoteusz Gedliczka, Krakow (PL); Andrzej Wrobel, Krakow (PL)

(21) Appl. No.: 15/408,349

(22) Filed: Jan. 17, 2017

(51) Int. Cl. G06F 17/30

(52) U.S. Cl. CPC G06F 17/30371

(57) ABSTRACT

A method and a related system for reconciling data sets from different data sources includes comparing the data sets using static data from the data sets, determining an uncertainty factor whether to reconcile the data sets based on an incomplete match of the static data of data sets, and performing a dynamic matching if the uncertainty factor exceeds a predefined uncertainty threshold value. The dynamic data matching comprises the following: comparing dynamic communication data relating to each of the data sets, determining a certainty factor based on the comparison of the dynamic communication data, and reconciling those data sets whose certainty factor exceeds a predefined certainty threshold value.

### BACKGROUND OF THE INVENTION

### Field of the Invention

The invention relates generally to a method for reconciling data sets, and in particular to a method for reconciling data sets from different data sources. The invention relates further to a related system for reconciling data sets from different data sources, and a computer program product.

### Description of the Related Art

Modern information technology (IT) environments require sophisticated systems management in order to coordinate and control all networked devices and software functions. Often, the IT components are distributed across a plurality of locations and work as loosely coupled systems under the cloud computing paradigm. In order to control the IT devices, typically, information technology systems management (ITSM) tools are used. In some cases, different tools are used for different management purposes of the same IT environment. In such a case it becomes paramount to clearly identify individual devices even if the control information is derived from different systems management tools. Examples for different systems management tools may be seen in tools for configuration management, for licensing, for performance monitoring, and so on. Usually, management data from multiple data sources are consolidated into one single tool like a portal to provide required data about IT assets to users and systems managers.

One unsolved problem in such a situation is how to reconcile systems management data from multiple sources, e.g., from different systems management tools. On the other side, the same problem may exist if system management data are provided to one or by one systems management tools if the data are collected via different routes or other intermediate data aggregators. Typically, operators rely on data received from endpoints of the IT environment like a serial number of the computer or other computing or network devices, a unified network identifier (UUID) or other characterizing information that make such an object or endpoint unique in the context of a given IT environment. In some cases, the data sources or data collectors may not have access to the complete set of identifying data of a specific server or endpoint or other computing device—e.g., if no security credentials are available to read out in IP address or a MAC (media access control) address. This may typically occur in virtualized environments using a hypervisor's or DMZ (de-militarized zone) because IP or MAC addresses may be reused several times.

### BRIEF SUMMARY OF THE INVENTION

According to one aspect of the present invention, a method for reconciling data sets from different data sources may be provided. The method may comprise comparing the data sets using static data of the data sets, and determining an uncertainty factor whether to reconcile the data sets based on an incomplete match of the static data of data sets. The method may further comprise performing a dynamic matching if the uncertainty factor exceeds a predefined uncertainty threshold value. The dynamic data matching may comprise the following: comprise comparing dynamic communication data relating to each of the data sets, determining a certainty factor based on the comparison of the dynamic communication data, and reconciling those data sets whose certainty factor exceeds a predefined certainty threshold value.

According to another aspect of the present invention, a system for reconciling data sets from different data sources may be provided. The system may comprise a first comparing unit adapted for a comparison of the data sets using static data from the data sets, and a first determination module adapted for a determination of an uncertainty factor whether to reconcile the data sets based on an incomplete match of the static data of data sets. The system may additionally comprise a dynamic matching module adapted for performing a dynamic matching if the uncertainty factor exceeds a predefined uncertainty threshold value. The dynamic data matching module may comprise the following: a second comparing unit adapted for a comparison of dynamic communication data relating to each of the data sets, a second determination module adapted for a determination of a certainty factor based on the comparison of the dynamic communication data, and a reconciliation unit adapted for a reconciliation of those data sets whose certainty factor exceeds a predefined threshold value.

Furthermore, embodiments may take the form of a related computer program product, accessible from a computer-usable or computer-readable medium providing program code for use, by or in connection with a computer or any instruction execution system. For the purpose of this description, a computer-usable or computer-readable medium may be any apparatus that may contain means for storing, communicating, propagating or transporting the program for use, by or in a connection with the instruction execution system, apparatus, or device.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 shows a block diagram of an embodiment of the inventive method for reconciling data sets from different data sources.

FIG. 2 shows a block diagram of a more detailed embodiment of the method for reconciling data sets.

FIG. 3 shows an embodiment of a system for reconciling data sets from different data sources.

FIG. 4 shows an embodiment of a computing system comprising the system for reconciling data sets from different data sources.

### DETAILED DESCRIPTION OF THE INVENTION

In the context of this description, the following conventions, terms and/or expressions may be used:

The term ‘reconcile’, in particular reconcile data, may denote the process of relating two data sets to each other. The data set may have some differences but may nevertheless relate to the same object the data sets are describing. The data sets may be received via different communication routes, at different times, by different tools, e.g., different systems management tools and/or at different times. In any case, there may be a need to decide whether two data sets may identify the same physical or logical device or a part thereof.

The term ‘data set’ may denote here characterizing an object in the physical world. That may be a device in an information technology (IT) infrastructure, like a computer, a network device, a storage device or even logical item, like a virtual machine or a file system or, parts thereof. It may also be a component of a device, such as a coprocessor or a power supply. Typically, the objects may be managed by a systems management tool which may identify the objects by means of the related data sets. Also virtual devices may count as existing object in the physical world, e.g., a VM (virtual machine), virtual network, virtual storage systems, etc.

The term ‘data sources’ may generally denote an origin of the data sets to be potentially reconciled. However, in a special case the data sets may be generated or originate by/from different systems management tools. They may also be received by the same systems management tool at different times or under otherwise different circumstances.

The term ‘static data’ may denote parts of the data set, in particular data fields which may not change during a communication process of the data, like device name, operating system (OS) name, OS type/version, IP address, etc. This may be in contrast to dynamic communication data.

The term ‘dynamic communication data’ may denote data that may be part of the data set or which may be related to the data and which comprise data values that are related to the communication process of the underlying data set. The dynamic communication data may be seen as meta data or supplementary data for the static data in the data set.

The term ‘uncertainty factor’ may denote a number value that may be derived from the number of data fields of the static data of the data set that match or may be identical. If, e.g., the data set may have 5 data values and 4 of those data values of two different data sets are identical, the uncertainty value may be 0.8 or 80%. Such an uncertainty factor may be simply calculated based on the number of matching data field of two different data sets. However, also more sophisticated algorithms for calculating the uncertainty factor may be used. The uncertainty factor may also reflect the type of data per data field. Some data field may be given a higher weighting in the calculation of the uncertainty factor than other data fields. Other algorithms may also reflect the type of device related to the data set.

The term ‘certainty factor’ may denote a number value derived from the comparison of the dynamic communication data that may be part of the data set or that may be related to the data set. Also here, different methods may be applied to compare the dynamic communication data. A matching function may be applied to the dynamic communication data giving some of the data field of the dynamic communication data a different weighting in comparison to other data fields of the dynamic communication data. Thus, the certainty factor may easily be adjusted as required for a certain IT environment.

The term ‘systems management tool’ may denote a software product—which may alternatively be partially or completely be implemented in hardware—instrumental for a controlling a plurality of devices, e.g., devices in an IT environment like a data center or a distributed IT environment. Beside physical devices, also application or virtual devices may be controlled and/or managed by the systems management tool.

The proposed method for reconciling data sets from different data sources may offer multiple advantages and technical effects:

The proposed method and system may allow for a better systems management of a complex IT environment because endpoints in such a networked environment comprising a plurality of individual computers, mobile devices, eventually sensors in an Internet-of-Things (IoT) environment, servers, storage devices, network devices, virtual machines, virtualizing software containers and so on, may be identified even if only a subset of typical static identification data for an individual device or an endpoint may be available. Thus, endpoints may clearly and unambiguously be identified even if only limited information may be accessible by a systems management tool. Such incomplete identification information for an endpoint may normally lead to time-consuming operator decisions, whether two data sets identify an identical endpoint. The proposed system may be enabled to also work with incomplete information and derive certainty and/or uncertainty factors in order to decide or determine about a probability that two data sets belong to the same physical object, i.e., the same physical device or endpoint in the IT environment. This way, an easier consolidation of data from different sources for the purpose of IT systems management may be performed. The different data sets may originate from different IT systems management tools or may be managed by the same IT systems management tool that may be collected in different ways with a potential disadvantage that they may not match. The proposed method and system is instrumental to match or reconcile the different data sets in order to uniquely identify an object to be managed by the IT systems management tool.

It may be noted that the proposed technology is not limited to the field of IT systems management. The method and the related system may also be applied to other IT fields like data matching in data warehouse environments, data consolidation, ETL (extract, transform, load), pattern matching and many others.

It may also be noted that the determination of the uncertainty factor and the certainty factor may be performed using different algorithms because the determination of the uncertainty factor is using the static data as determination basis, whereas the dynamic matching or, the comparison of the dynamic communication data, respectively, are based on a different set and number of data, namely, the dynamic communication data.

According to one permissive embodiment of the method, each of the data sets may relate to an object to be managed by a systems management tool. This may enable to unambiguously identify endpoints in an IT environment even if the characterizing data sets of an endpoint may be incomplete or may not match completely if coming from, e.g., different systems management tools.

According to one preferred embodiment of the method, the static data may comprise at least one out the group comprising a device name—e.g., a computer name or identifier, or the same for a printer, disk system, and archiving system, a networking device, or the like—an operating system name—and in particular in combination with a version and/or release number of the operating system—an IP (Internet Protocol) address, a NAT (network address translation) name. A skilled person may extend the list of potentially identifying data fields for computing endpoints in an IT environment.

According to an advantageous embodiment of the method, the dynamic communication data comprise at least one out the group comprising a number of network hops, an average ping time—e.g. ICMPv6 echo request—and entries in a traceroute table. Also here, the list of the dynamic communication data characterizing the way the static data in the data set have been transmitted from the endpoint to the reconciliation system may be extended by a skilled person. The kind of available data may depend on the implemented network technology and related protocols.

According to one additional advantageous embodiment of the method, two data sets may only then be reconciled if the data sets are received within a predefined time interval. This is because the received data sets—comprising the static data and potentially also the dynamic communication data—may depend on workloads of the IT environment—and thus the endpoints, and/or performed updates between the generation time of two data sets and so on.

According to one permissive embodiment of the method, the data sets to be reconciled may originate from different systems management tools. This may be a typical application area of the proposed method and system. It may allow to uniquely identifying endpoints in an IT environment. No operator interaction with a systems management tool may be required. Endpoints may unambiguously be identified and thus be managed and controlled by the system management tool(s).

According to another advantageous embodiment of the method, the threshold value of the uncertainty factor and/or the certainty factor may be dependent on a type of object the data set is related to. Different types of endpoints may be characterized and identified by different static data in the related data sets. A server's name may have a higher level of uniqueness than a name of a personal computer or, a mobile device or a sensor in an IoT environment. Therefore, the reliability of a subset of the static data of a server may be higher than in an equivalent subset of the set of data of a virtual machine that may be deployed several thousand times. As explained above, IP addresses may be reused in virtualized environments. Thus, if only an IP address may be available as part of the static data, it might not be enough to unambiguously identify an endpoint and an IT environment. Consequently, and as an example, the threshold value may be relatively low for a virtual machine in comparison to a physical server or an archiving system, of which only one single system may be deployed in a complex IT environment.

According to one preferred embodiment of the method, the uncertainty factor may be a function of a number of matching data fields in the static data of the data sets. Additionally, the reconciliation may only be performed if a predefined uncertainty threshold value is undercut. Thus, it may only be determined that two non-directly matching data sets belong to the same physical device in the IT environment if the uncertainty threshold stays below a predefined maximum value.

In the following, a detailed description of the figures will be given. All instructions in the figures are schematic. Firstly, a block diagram of an embodiment of the inventive method for reconciling data sets from different data sources is given. Afterwards, further embodiments, as well as embodiments of the system for reconciling data sets from different data sources will be described.

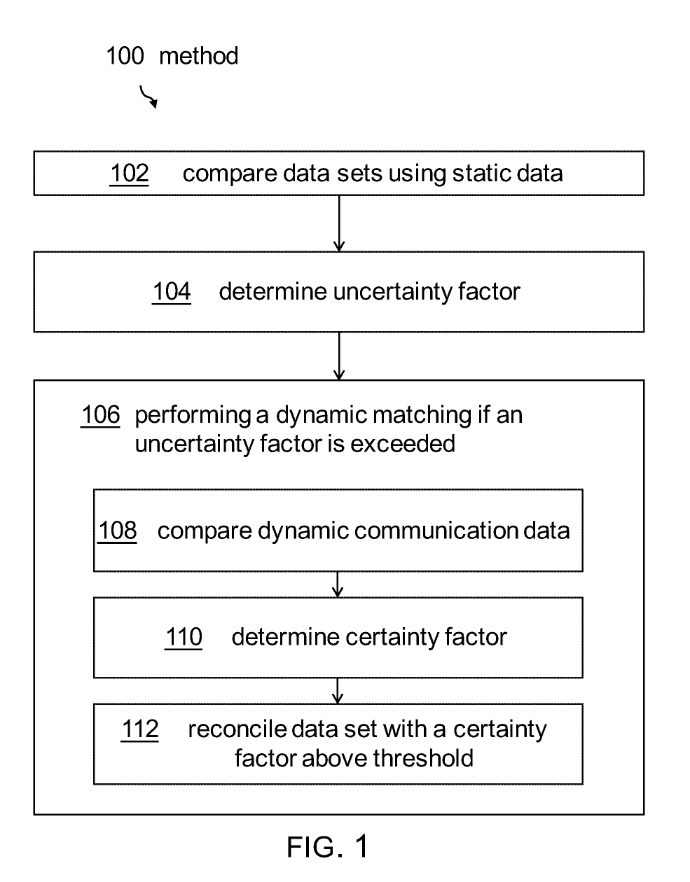

FIG. 1 shows a block diagram of an embodiment of the method 100 for reconciling data sets from different data sources, which may be different ITSM tools. Alternatively, the different data sets may be received via different routes by the same tool. The method comprises comparing, 102, the data sets using static data from the data sets and determining, 104, an uncertainty factor whether to reconcile the data sets based on an incomplete match of the static data of data sets. The uncertainty factor may be based on the number of matching fields of the two data sets. Furthermore, the method 100 comprises performing a dynamic matching 106 if the uncertainty factor exceeds a predefined uncertainty threshold value. The dynamic data matching comprises the following: comparing, 108, dynamic communication data relating to each of the data sets. These dynamic communication data may be added to the data set or may be related to the data set as a sort of metadata during the time the data set may be transmitted from the endpoint to be controlled in the IT environment to the system management tool or the reconciliation system.

Furthermore, the method 100, in particular the dynamic matching, comprises determining, 110, a certainty factor based on the comparison of the dynamic communication data and reconciling, 112, those data sets whose certainty factor exceeds a predefined certainty threshold value, e.g., above 80 or 90%. However, such a threshold value may be set individually by an operator for a given IT environment. Default values may be used. As a result, an object of a systems management tool may uniquely be identified even if the different characteristic data are available in the data set.

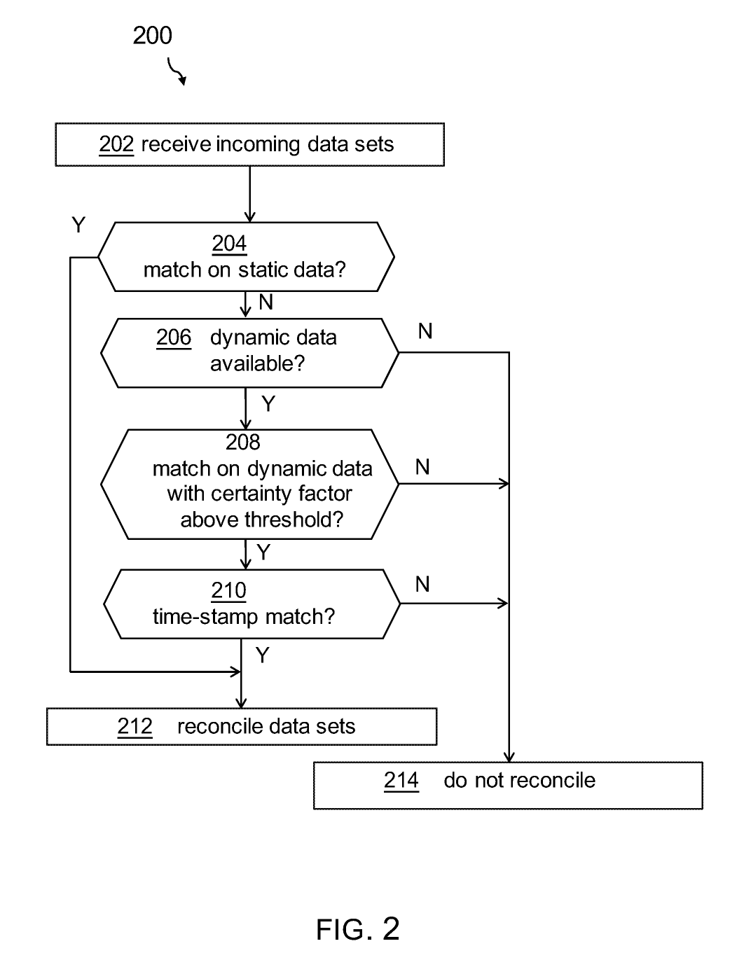

FIG. 2 shows a block diagram of a more detailed embodiment 200 of the method for reconciling data sets. Initially, the data sets are received, 202. It may then be determined, 204, if there is a match of the static data or part thereof of the different data sets. In case of “YES”, the data sets are reconciled, 212, for a unique identification of an endpoint in an IT environment. If the static data do not match, it may be determined, 206, whether dynamic communication data are available in addition to the static data for each of the data sets. Then it may be determined, 208, whether there is a match of dynamic communication data, in particular of certain data fields of the dynamic communication data. Based on such a match/mismatch a certainty factor will be derived. If a complete match of dynamic communication data for the invoice data sets is determined, the certainty factor is 100%. Lower certainty factors may be determined if only a limited number of data fields of the dynamic communication data of the different data sets are available. If the certainty factor is below a predefined threshold value, no reconciliation happens, 214. The same applies, of course, if no dynamic communication data are available for at least one of the data sets to be reconciled.

In addition to the certainty factor determined on the basis of the dynamic communication data it is determined, 210, whether the time-stamps of the two different dynamic communication data sets lie within a predefined time frame. If that is not the case—e.g., if the data sets are from two different days implying potentially completely different network performance and thus, a different inherent communication characteristic—no reconciliation happens, 214. In such a case, an operator may have to decide whether the different data sets may belong to the same endpoint.

It may also be noted, that the certainty factor may be decreased by a predefined value—e.g., 1% per hour between the capture time or time-stamp of the invoice data sets—over time.

In order to make the functioning of the method a little bit more comprehensive, an example for static data is given be given:

Data set 1 and 2 may comprise the following data fields:

| data field | data set 1 value | data set 2 value |
|---|---|---|
| 1 | LinuxUnitaryComputerSystem | LinuxUnitaryComputerSystem |
| 2 | hostname1 | hostname1 |
| 3 | 42369DC6 | 42369DC6 |
| 4 | 192.168.1.1 | 192.168.1.1 |
| 5 | 192, 168.1.2 | 192.168.1.2 |
| 6 | null | 5 |
| 7 | null | 40 ms |

It may be assumed that the first 5 data fields may relate to static data and the data fields 6 and 7 may relate to dynamic communication data fields. Data field 6 may, e.g., relate to the number of hops the data package/data set may have needed to be received by the reconciliation system, and the data field 7 may relate to an average ping time. Based on the availability of dynamic communication data in the data sets, the complete method may be performed or not. In the case shown above, data set 1 does not comprise the required dynamic communication data. Thus, no reconciliation may be performed for these exemplary data sets.

In another example—including dynamic communication data—the 3 data sets may have the following structure and content:

| data field | data set 1 value | data set 2 value | data set 3 value |
|---|---|---|---|
| type | UnitaryLinux | ComputerSystem 2 | ComputerSystem 3 |
| | ComputerSystem 1 | | |
| name | hostname1 | null | null |
| UUID | 42369DC6 | null | null |
| IP 1 | 192.168.1.1 | 192.168.1.1 | null |
| IP 2 | 192, 168.1.2 | null | 192, 168.1.2 |
| number of network | 3 [R1, R2, SW1] | 3 [R1, R2, SW1] | 5 [R3, R4, R1, SW1, |
| hops (TTL) | | | SW2] |
| average ping time | 40 ms | 38 ms | 100 ms |
| time-stamp | 1464770174 | 1464770174 | 1464770174 |

In this example, 3 data sets of 3 potentially different or potentially equal endpoints are compared. The last 3 data fields of the data sets may relate to dynamic communication data. It may also be noted that some data fields comprise the value “null”. Whereas the 1^{st} data set is complete, data set 2 and data set 3 is each incomplete. Thus, a certain uncertainty factor may be derived based on the number of non-available data fields in the static data and/or a mismatch between the data values of the static data fields. Any algorithm may be applied. A missing value may cause lower uncertainty factor in comparison to different entries in the related static data fields. It may even be decided that whenever two related static data values do not match, no reconciliation happens. In cases in which data fields are empty (“null”) a linear function may be used for every missing data value; e.g., in case of one missing data field value and 5 potential static data values, each missing data field may increase the uncertainty factor by 20%, because each data field may have a weight of ⅕^{th} or 20%. The determination of the certainty factor may be based on the 3 last data fields of the data sets, namely a number of network hops, an average ping time and or a time-stamp within a predefined time frame.

It may be noted that the data sets 1 and 2 are pretty identical. On the dynamic communication data side, the number of network hops, and the time-stamp are identical. Only the average ping time varies in 2 ms. Thus, the probability that the two data sets identify the same device is comparably high.

On the other side, data set 1 and 3 have matching values in the second IP address and the time-stamp. However, the other dynamic communication data are different to a large extent: The number of network hops is 5 vs. 3 and the average ping time is 100 ms instead of 40 ms. Thus, it seems to be pretty probable that the two data sets 1 and 3 do not refer to the same, identical device, although the time stamp is identical.

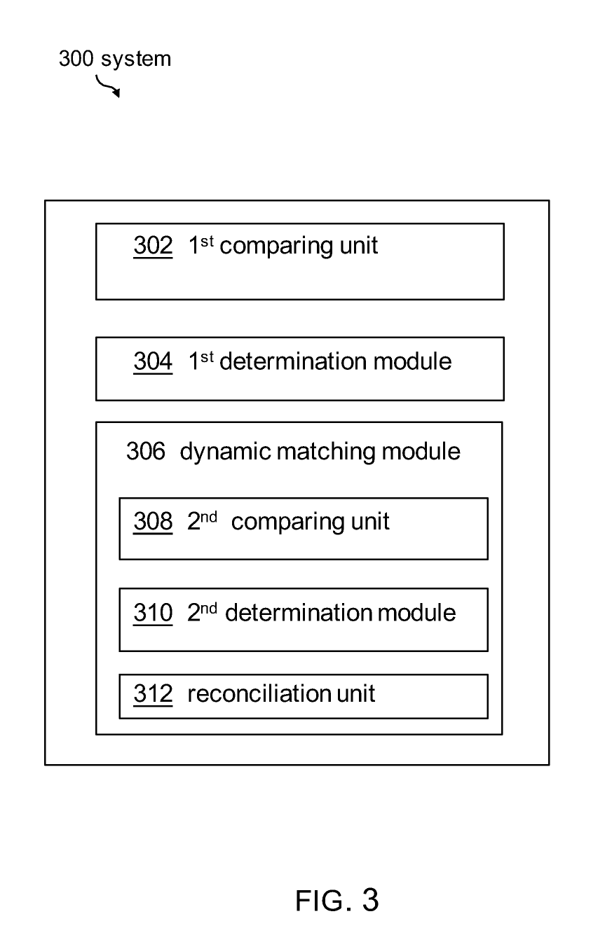

FIG. 3 shows an embodiment of a system 300 for reconciling data sets from different data sources. The system 300 comprises a first comparing unit 302 adapted for a comparison of the data sets using static data—i.e., data field values comprising static data—from the data sets, a first determination module 304 adapted for a determination of an uncertainty factor whether to reconcile the data sets based on an incomplete match of the static data of data sets. The system comprises further a dynamic matching module 306 adapted for performing a dynamic matching if the uncertainty factor exceeds a predefined uncertainty threshold value. The dynamic data matching module 306 comprises the following: a second comparing unit 308 adapted for a comparison of dynamic communication data relating to each of the data sets and a second determination module 310 adapted for a determination of a certainty factor based on the comparison of the dynamic communication data, and a reconciliation unit 312 adapted for a reconciliation of those data sets whose certainty factor exceeds a predefined threshold value.

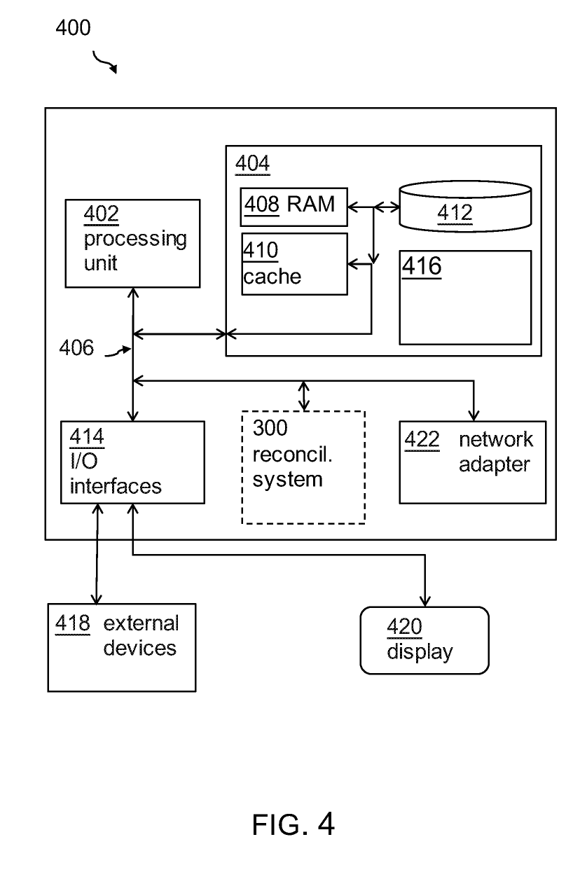

Embodiments of the invention may be implemented together with virtually any type of computer, regardless of the platform being suitable for storing and/or executing program code. FIG. 4 shows, as an example, a computing system 700 suitable for executing program code related to the proposed method.

The computing system 400 is only one example of a suitable computer system and is not intended to suggest any limitation as to the scope of use or functionality of embodiments of the invention described herein. Regardless, computer system 400 is capable of being implemented and/or performing any of the functionality set forth hereinabove. In the computer system 400, there are components, which are operational with numerous other general purpose or special purpose computing system environments or configurations. Examples of well-known computing systems, environments, and/or configurations that may be suitable for use with computer system/server 400 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like. Computer system/server 400 may be described in the general context of computer system-executable instructions, such as program modules, being executed by a computer system 400. Generally, program modules may include routines, programs, objects, components, logic, data structures, and so on that perform particular tasks or implement particular abstract data types. Computer system/server 400 may be practiced in distributed cloud computing environments where tasks are performed by remote processing devices that are linked through a communications network. In a distributed cloud computing environment, program modules may be located in both local and remote computer system storage media including memory storage devices.

As shown in the figure, computer system/server 400 is shown in the form of a general-purpose computing device. The components of computer system/server 400 may include, but are not limited to, one or more processors or processing units 402, a system memory 404, and a bus 406 that couples various system components including system memory 404 to the processor 402. Bus 406 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. Computer system/server 400 typically includes a variety of computer system readable media. Such media may be any available media that is accessible by computer system/server 400, and it includes both, volatile and non-volatile media, removable and non-removable media.

The system memory 404 may include computer system readable media in the form of volatile memory, such as random access memory (RAM) 408 and/or cache memory 410. Computer system/server 400 may further include other removable/non-removable, volatile/non-volatile computer system storage media. By way of example only, storage system 412 may be provided for reading from and writing to a non-removable, non-volatile magnetic media (not shown and typically called a ‘hard drive’). Although not shown, a magnetic disk drive for reading from and writing to a removable, non-volatile magnetic disk (e.g., a ‘floppy disk’), and an optical disk drive for reading from or writing to a removable, non-volatile optical disk such as a CD-ROM, DVD-ROM or other optical media may be provided. In such instances, each can be connected to bus 406 by one or more data media interfaces. As will be further depicted and described below, memory 404 may include at least one program product having a set (e.g., at least one) of program modules that are configured to carry out the functions of embodiments of the invention.

Program/utility 414, having a set (at least one) of program modules 416, may be stored in memory 404 by way of example, and not limitation, as well as an operating system, one or more application programs, other program modules, and program data. Each of the operating system, one or more application programs, other program modules, and program data or some combination thereof, may include an implementation of a networking environment. Program modules 416 generally carry out the functions and/or methodologies of embodiments of the invention as described herein.

The computer system/server 400 may also communicate with one or more external devices 418 such as a keyboard, a pointing device, a display 420, etc.; one or more devices that enable a user to interact with computer system/server 400; and/or any devices (e.g., network card, modem, etc.) that enable computer system/server 400 to communicate with one or more other computing devices. Such communication can occur via Input/Output (I/O) interfaces 414. Still yet, computer system/server 400 may communicate with one or more networks such as a local area network (LAN), a general wide area network (WAN), and/or a public network (e.g., the Internet) via network adapter 422. As depicted, network adapter 422 may communicate with the other components of computer system/server 400 via bus 406. It should be understood that although not shown, other hardware and/or software components could be used in conjunction with computer system/server 400. Examples, include, but are not limited to: microcode, device drivers, redundant processing units, external disk drive arrays, RAID systems, tape drives, and data archival storage systems, etc.

Additionally, the system 300 for reconciling data sets from different data sources may be attached to the bus system 406.

The descriptions of the various embodiments of the present invention have been presented for purposes of illustration, but are not intended to be exhaustive or limited to the embodiments disclosed. Many modifications and variations will be apparent to those of ordinary skills in the art without departing from the scope and spirit of the described embodiments. The terminology used herein was chosen to best explain the principles of the embodiments, the practical application or technical improvement over technologies found in the marketplace, or to enable others of ordinary skills in the art to understand the embodiments disclosed herein.

The present invention may be embodied as a system, a method, and/or a computer program product. The computer program product may include a computer readable storage medium (or media) having computer readable program instructions thereon for causing a processor to carry out aspects of the present invention.

The medium may be an electronic, magnetic, optical, electromagnetic, infrared or a semi-conductor system for a propagation medium. Examples of a computer-readable medium may include a semi-conductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-RAY), DVD and Blu-Ray-Disk.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Smalltalk, C++ or the like, and conventional procedural programming languages, such as the “C” programming language or similar programming languages. The computer readable program instructions may execute entirely on the user's computer, partly on the user's computer as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus', and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus', or another device to cause a series of operational steps to be performed on the computer, other programmable apparatus or other device to produce a computer implemented process, such that the instructions which execute on the computer, other programmable apparatus', or another device implement the functions/acts specified in the flowchart and/or block diagram block or blocks.

The flowcharts and/or block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or act or carry out combinations of special purpose hardware and computer instructions.

The terminology used herein is for the purpose of describing particular embodiments only and is not intended to limit the invention. As used herein, the singular forms “a”, “an” and “the” are intended to include the plural forms as well, unless the context clearly indicates otherwise. It will further be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or steps plus function elements in the claims below are intended to include any structure, material, or act for performing the function in combination with other claimed elements, as specifically claimed. The description of the present invention has been presented for purposes of illustration and description, but is not intended to be exhaustive or limited to the invention in the form disclosed. Many modifications and variations will be apparent to those of ordinary skills in the art without departing from the scope and spirit of the invention. The embodiments are chosen and described in order to best explain the principles of the invention and the practical application, and to enable others of ordinary skills in the art to understand the invention for various embodiments with various modifications, as are suited to the particular use contemplated.

We claim:

1. A method for reconciling data sets from different data sources, said method comprising
comparing said data sets using static data from the data sets,
determining an uncertainty factor whether to reconcile said data sets based on an incomplete match of said static data of data sets,
performing a dynamic matching if said uncertainty factor exceeds a predefined uncertainty threshold value, wherein said dynamic data matching comprises the following:
comparing dynamic communication data relating to each of said data sets,
determining a certainty factor based on said comparison of said dynamic communication data, and
reconciling those data sets whose certainty factor exceeds a predefined certainty threshold value.

2. The method according to claim 1, wherein each of said data sets relates to an object to be managed by a systems management tool.

3. The method according to claim 1, wherein said static data comprise at least one out of the group comprising a device name, an operating system name, an IP address, a NAT name.

4. The method according to claim 1, wherein said dynamic communication data comprise at least one out of the group comprising a number of network hops, an average ping time, and entries in a traceroute table.

5. The method according to claim 1, wherein two data sets are only then reconciled if said data sets are received within a predefined time interval.

6. The method according to claim 1, wherein said data sets to be reconciled originate from different systems management tools.

7. The method according to claim 1, wherein said threshold value is dependent on a type of object said data set is related to.

8. The method according to claim 1, wherein said uncertainty factor is a function of a number of matching data fields in said static data of said data sets, and wherein said reconciliation is only performed if the predefined uncertainty threshold value is undercut.

9. A system for reconciling data sets from different data sources, said system method comprising:
a first comparing unit adapted for a comparison of said data sets using static data from the data sets,
a first determination module adapted for a determination of an uncertainty factor whether to reconcile said data sets based on an incomplete match of said static data of data sets,
a dynamic matching module adapted for performing a dynamic matching if said uncertainty factor exceeds a predefined uncertainty threshold value, wherein said dynamic data matching module comprises the following:
a second comparing unit adapted for a comparison of dynamic communication data relating to said each of said data sets,
a second determination module adapted for a determination of a certainty factor based on said comparison of said dynamic communication data, and
a reconciliation unit adapted for a reconciliation of those data sets whose certainty factor exceeds a predefined threshold value.

10. The system according to claim 9, wherein each of said data sets relates to an object to be managed by a systems management tool.

11. The system according to claim 9, wherein said static data comprise at least one out of the group comprising a computer name, an operating system name, an IP address, a NAT name.

12. The system according to claim 9, wherein said dynamic communication data comprise at least one out of the group comprising a number of hops, an average ping time, and a trace route table.

13. The system according to claim 9, wherein two data sets are only then reconciled if said data sets are received within a predefined timeframe.

14. The system according to claim 9, wherein said data sets to be reconciled originate from different systems management tools.

15. The method according to claim 9, wherein said threshold value is dependent on a type of object a data set is related to.

16. The system according to claim 9, wherein said uncertainty factor is a function of a number of matching data fields in said static data of said data sets, and wherein said reconciliation unit is adapted to only performed said reconciliation if the predefined uncertainty threshold value is undercut.

17. A computer program product for reconciling data sets from different data sources, said computer program product comprising a computer readable storage medium having program instructions embodied therewith, said program instructions being executable by one or more computing systems to cause said one or more computing systems to:
compare said data sets using static data from the data sets,
determine an uncertainty factor whether to reconcile said data sets based on an incomplete match of said static data of data sets,
perform a dynamic matching if said uncertainty factor exceeds a predefined uncertainty threshold value, wherein said dynamic data matching comprises the following:
compare dynamic communication data relating to said each of said data sets,
determine a certainty factor based on said comparison of said dynamic communication data, and
reconcile those data sets whose certainty factor exceeds a predefined threshold value.
